(19) United States
(12) Patent Application Publication
(10) Pub. No.: US 2003/0186199 A1
(43) Pub. Date: Oct. 2, 2003

(54) System and method for interactive online training

(75) Inventors: Bryon E. McCool, Trussville, AL (US); David W. Mitchell, Hoover, AL (US)

Correspondence Address: BROOKS & KUSHMAN, 1000 TOWN CENTER 22ND FL, SOUTHFIELD, MI, 48075

(73) Assignee: Melior-Delaware, Birmingham, AL

(21) Appl. No.: 10/350,966

(22) Filed: Jan. 23, 2003

Related U.S. Application Data
(60) Provisional application No. 60/351,305, filed on Jan. 23, 2002.

(51) Int. Cl. G09B 19/00

(52) U.S. Cl. 434/219

(57) ABSTRACT

Online method, system and software for interactively training a user to use a device. One or more computers are operably programmed and configured to display instruction for using a device, display an interactive graphical simulation of the device, receive user input configuring the device, and display a result of the user configuring the device. In another embodiment, the device automatically is synchronized to a particular segment of the instruction. Instructions for configuring or using the device in a particular manner may be provided to a user, together with an indication as to whether the resulting user configuration is correct (e.g., online exercises, quizzes, examinations, etc.) Online communication may be established between user-trainees and device manufacturers for user support, product feedback, etc. A wide variety of devices and device usages or configurations may be simulated, including but not limited to vehicle diagnostic, electrical, and medical devices and related applications.

### CROSS-REFERENCE TO RELATED APPLICATIONS

This application claims the benefit of U.S. provisional application Serial No. 60/351,305 filed Jan. 23, 2002.

### BACKGROUND OF THE INVENTION

Today, universities and other educational institutions offer students with online courses capable of providing remote students with “electronic” curriculum (e.g. over the World Wide Web). In other instances, such electronic curriculum is provided to students as a stand-alone application (i.e., embodied in a compact disc) or running on computers that are owned or maintained by teaching or training institutions themselves. Many large companies offer online instruction to their employees via corporate intranets and extranets. Such corporate training is typically limited in scope to the particular type of business a corporation is involved in.

The benefits associated with online instruction are well-known. The World Wide Web, for example, has been widely held as one of the most efficient and effective educational mediums available to the public. Course content can be made available, at any time, to students located virtually anywhere. Curriculum for such courses can range from simple written format to detailed pictures, streaming video and synchronized audio. Translations for courses are readily provided to overcome language barriers. Student enrollment and registration processes are streamlined. For online examinations, the grading process is typically instantaneous.

One disadvantage of known methods and systems for online instruction, however, is their inability to provide “hands-on” training to students. For example, a conventional classroom course in applied electrical circuits typically involves hands-on student training for a “multi-meter” device to test circuit voltage, current and resistance. Other “hands-on” devices for such a course might include a power supply, a signal generator and an oscilloscope. Conventional classroom curriculum relies on such hands-on experience to enhance students' educational experience (i.e., learn-by-doing).

Conventional online courses cannot provide students with such “hands-on” training. This conventional online instruction cannot provide students with the benefit of physically operating devices (e.g., multi-meter, power supply, etc.) during instruction. As such, students cannot enjoy the experience of applying classroom instruction in a physical sense.

Notably, this disadvantage is not limited to online courses in applied electrical circuits. Virtually any online curriculum relating to or involving the operation of a physical device suffers from the same drawback. In the automotive industry, for example, a course relating to a vehicle diagnostic device requires that a service technician know how to properly configure, connect to a vehicle and operate the device. Such devices are extremely complicated and involve many configurations and functions. In the medical industry for example, a course relating to a programmable infusion device requires that a nurse or medical technician know how to properly calculate drug doses, program start and stop, program flow rates, etc. The range of courses which involve training students to use physical devices is unlimited.

Another drawback associated with training students to use physical devices is the inability to easily keep students “on track” or “in sync” with the instruction. For example, it is common for students handling new devices to “play” with them—i.e., change settings, push buttons, turn knobs, etc. Although this type of “hands-on” curiosity has a tremendous educational value, students typically get too far ahead of the instruction or simply “get lost” in the device. Students then have a problem re-configuring the device back to the proper configuration so they can continue following along with the instruction. Notably, this drawback is not limited to online instruction, but also includes conventional laboratory or classroom instruction.

In conventional training situations where students get off-pace with their device, an instructor must physically stop instructing the class and take time to re-configure that student's device to be “in sync” with the instruction. This is particularly problematic where the class consists of many curious students. Not surprisingly, training is repeatedly disrupted in such situations and inevitably leads to discontinuity in thought for the students. Such delays and interruptions decrease the effectiveness of the training.

What is needed is an innovative method and system for instructing students to use physical devices in an online setting that overcomes these and other drawbacks associated with the prior art.

### SUMMARY OF THE INVENTION

The present invention is an advantageous alternative to prior art methods and systems for instructing students to use physical devices in an online setting. For example, one aspect of the present invention enables a student user to physically operate simulations of the devices in a true-to-life fashion. This advantage allows the student user to learn by engaging in activities not effectively supported by many prior art methods and systems. In addition, student users may interactively configure or “use” the simulated devices without risk of damaging the devices themselves, or the devices they may be interconnected with.

Another advantageous aspect of the present invention enables a student user to synchronize the configuration of his of her simulated device to the particular instruction or instruction segment. This aspect of the present invention is particularly advantageous when a student user configures or otherwise finds the simulated device “off-track” with a particular instruction segment. This aspect of the present invention improves continuity of student thought by minimizing distraction and thereby increases the overall effectiveness of the training.

Yet another advantageous aspect of the present invention enables a student or trainee to seek online technical support directly from a manufacturer of a device included in the online instruction. This feature is advantageous for several reasons. First, students can receive assistance and support directly from the manufacturer—the entity most knowledgeable about the device and its operation. Second, manufacturer tutor support facilitates an ongoing dialog between the manufacturer of a device and users of that device. This type of user feedback is valuable to the manufacturer, as the users may provide product complaints, improvement recommendations, etc. Manufacturers may use this feedback in design and manufacturing to improve the quality, usability, functionality etc., of their products.

To meet these and other objects, advantages and features of the present invention, a system, method and software for online training are provided. Embodiments of the present invention include one or more computers configured to display instruction for using a device and an interactive graphical simulation of the device. Users present input configuring the simulated device in a true-to-life fashion. In response, a result of the user configuring the device is provided. Online instruction may be automatically synchronized to the configuration of the simulated device in instances where students get “off-track” with instruction. The system may be programmed and configured to display an indication as to whether a particular device configuration is correct (e.g., during an online exercise, quiz or examination).

Embodiments of the present invention may be implemented over a variety of platforms including the Internet and World Wide Web. Online communication may be established between users/trainees and device manufacturers for support and feedback relating to the interactive devices.

### BRIEF DESCRIPTION OF THE DRAWINGS

FIG. 1 is an example graphical user interface including an example interactive simulated device in accordance with an aspect of the present invention;

FIG. 2 is an example graphical user interface including an example interactive simulated device that has been configured in accordance with an aspect of the present invention;

FIG. 3 is an example graphical user interface including an example interactive simulated device and an example experiment in accordance with an aspect of the present invention;

FIG. 4 is an example graphical user interface including an example instruction and corresponding interactive simulated device in accordance with an aspect of the present invention; and

FIG. 5 is an example graphical user interface including an example instruction and corresponding interactive simulated device that is shown out-of-sync with the example instruction in accordance with an aspect of the present invention; and

FIG. 6 is an example system configuration for implementing aspects of the present invention.

### DETAILED DESCRIPTION OF THE PREFERRED EMBODIMENT(S)

The following detailed description describes and illustrates preferred embodiments of the invention. As such, a wide variety of embodiments are envisioned and/or may be implemented in the future without departing from the scope of the claimed invention. The preferred embodiments described and illustrated should not act to limit the scope of the claimed invention.

Those of ordinary skill in the art will recognize that aspects of the present invention illustrated and described herein may be coded with a variety software tools including but not limited to Macromedia Flash. Macromedia Flash can be obtained from Macromedia Incorporated, 600 Townsend Street, San Francisco, Calif. 94103. Aspects of the present invention may be executed or otherwise run using a variety of software applications including but not limited to Microsoft Internet Explorer or Netscape navigator having an appropriate plug-in corresponding to the particular code format utilized (e.g., Macromedia Flash, etc.). Microsoft Internet Explorer can be obtained from Microsoft Corporation. Netscape Navigator can be obtained from Netscape Communications Corporation.

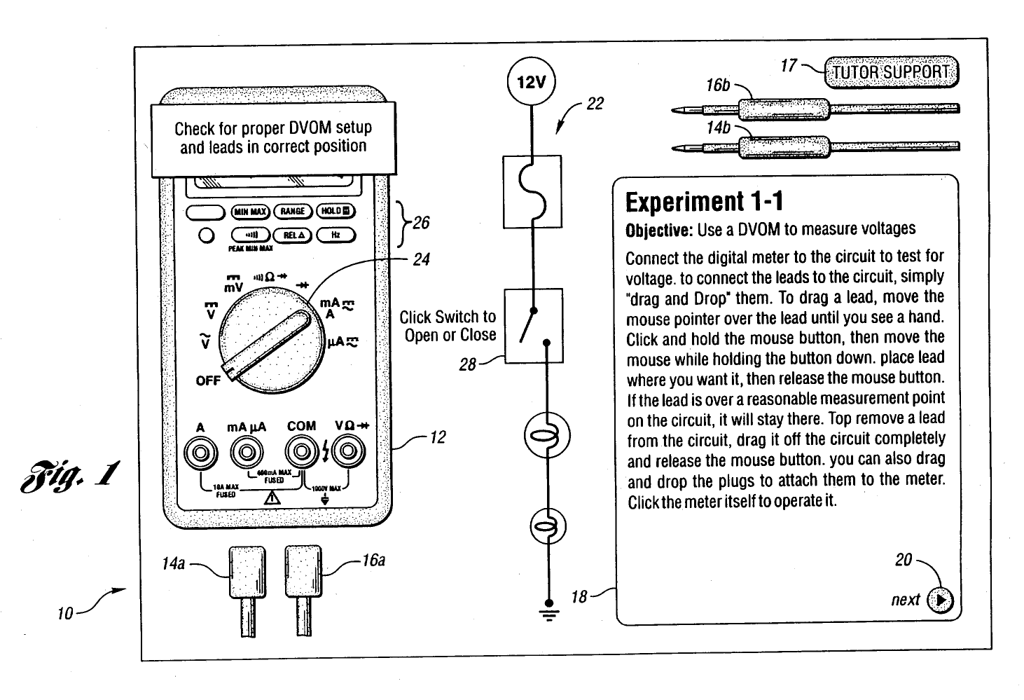

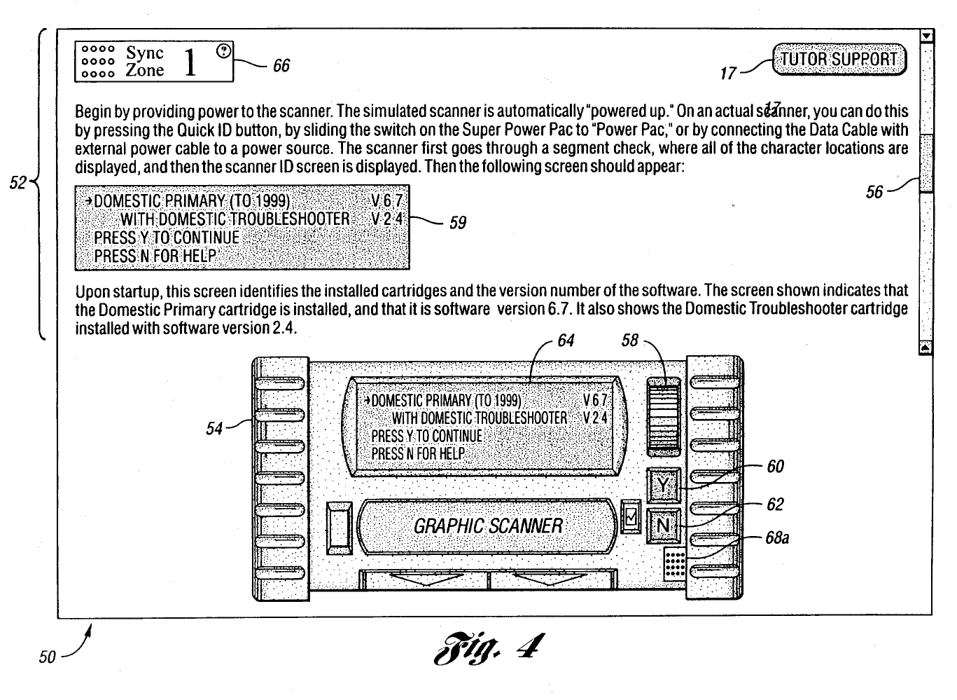

FIG. 1 is an example interactive graphical user interface (GUI) 10 for instructing a student to configure and use a physical device (e.g., simulated multi-meter 12). Those of ordinary skill in the art will recognize that the simulated device and training described in greater detail below may involve any physical device ranging from a wide variety of disciplines (e.g., mechanical, electrical, chemical, medical, aeronautical, etc.). For example, the simulated device shown in FIG. 4 is a Snap-On® MTG2500 Color Graphing Scanner used for vehicle diagnosis. This device is available from Snap-On Incorporated, P.O. Box 1430, Kenosha, Wis. 53141-1430. A simulated medical device might include, for example, a Gemini® programmable infusion pump. This device is available from ALARIS Medical Systems, Inc. 10221 Wateridge Circle, San Diego, Calif. 92121-2733. Notably, the content, arrangement and function illustrated and described with respect to FIG. 1 may be readily adapted to best-fit a particular implementation of the present invention.

In accordance with a preferred embodiment, interactive GUI 10 includes a physical device (i.e., multi-meter 12 including meter leads 14a, 14b, 16a, 16b), and instruction 18. Instruction 18 may be provided in a variety of formats including static text, scrolling text, audio, video, etc. Hypertext links (not shown) or buttons 20 may also be provided for providing access to other information (e.g., definitions, pictures, further description, next steps, etc.). Instruction 18 instructs a user (e.g., student or trainee) on how to “use” the physical device. Use of the device may include turning the device on, configuring the device, attaching the device to other devices or objects, operating the device, providing input to the device, reading or otherwise transmitting output to the device, etc.

In the example provided in FIG. 1, a student is instructed to configure a multi-meter 12 and apply the multi-meter to an example circuit 22 to test for voltage. In accordance with a preferred embodiment of the present invention, the student is provided with functionality for physically configuring and applying the simulated multi-meter 12 to the example electrical circuit 22. It is expected that the student will do so in accordance with instruction 18, however, interactive GUI 10 may support additional configurations of multi-meter 12 (and leads 14 and 16) or application of that configuration to the example circuit 22.

To configure the interactive multi-meter 12, the user selects the appropriate position for dial 24 and/or function buttons 26. Those of ordinary skill in the art will recognize, however, that user input to configure or apply the particular physical device may include and not be limited to “clicking”, “dragging” and/or “dropping” with a mouse or touch-pad, initiating a “mouse-over” event, operating a mouse roller, etc.

To apply the multi-meter 12 to the example circuit 22, the user may physically “drag” the meter leads 14a and 16a to the desired locations on multimeter 12 and lead-ends 14b and 16b, respectively, to the desired locations on example circuit 22. In this example, if the leads and lead ends are dragged to reasonable locations on the multi-meter 12 and example circuit 22 respectively, they will remain in that location. In this example, simulated power is applied to the example circuit 22 by selecting (i.e., “closing”) the simulated switch 28.

“Tutor Support” Button 17 enables a student to seek online assistance with using or applying device 12. In accordance with a preferred embodiment of the present invention, students can obtain tutor support directly from the manufacturer of device 12. This aspect of the present invention allows students to receive assistance and support directly from the manufacturer—the entity typically most knowledgeable about the device and its operation. An added advantage of this aspect of the present invention enables the manufacturer to enjoy an ongoing dialog with users of their respective devices 12. This type of user feedback is valuable to the manufacturer, as the users may provide product complaints, improvement recommendations, etc. Manufacturers may use this feedback in design and manufacturing to improve the quality, usability, functionality etc., of their products.

Those of ordinary skill in the art will recognize that online communication between students and device manufacturers may be supported in a variety fashions and formats. For example, upon selecting “Tutor Support” button 17, an Internet messaging, chat sessions, web cam, e-mail, etc. may be initiated establishing an operable communication link between a student and the manufacturer of a device 12 such as the multi-meter illustrated in FIG. 1.

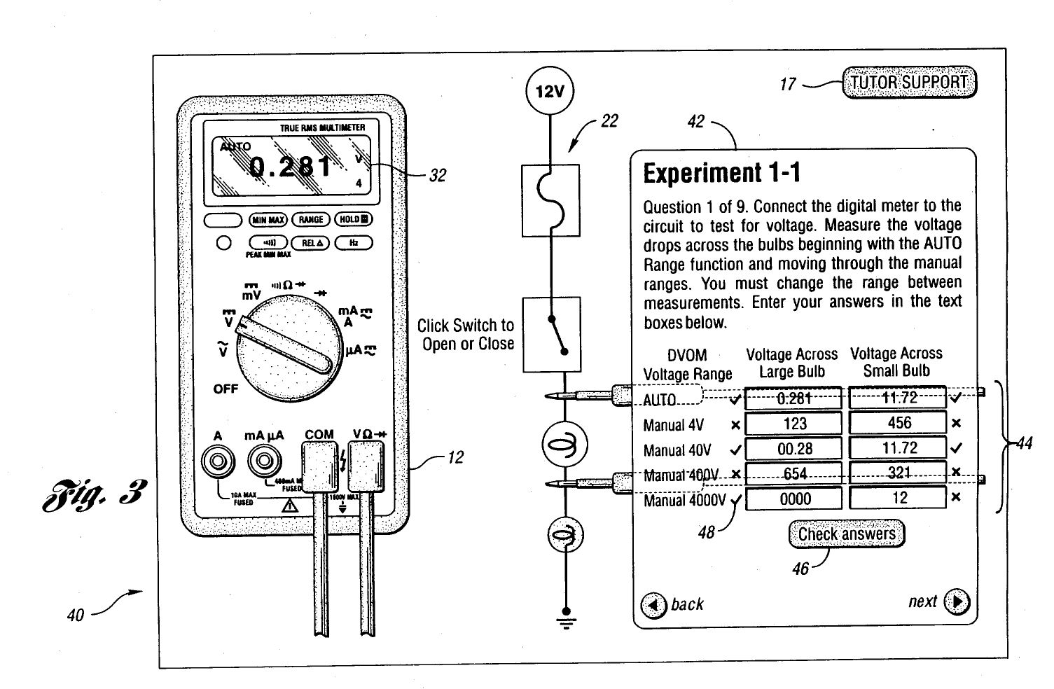

FIG. 3 is an interactive GUI 30 showing the multi-meter 12 and leads 14 and 16 interactively applied to the example circuit 22 in accordance with a preferred embodiment of the present invention. Notably, the multi-meter 12 outputs a simulated (yet accurate) measurement 32 based on the user-defined configuration of the multi-meter 12 and the position of the leads 14a, 16a and lead ends 14b, 16b, respectively. In this example, the voltage drop from point “A” to point “B” in the simulated circuit 22 is 0.281 volts. In this manner, a result of the user configuration is provided. Results from user configurations will vary widely based on the nature and operation signal generator of the device. For example, the result of configuring might include a waveform having a particular frequency and amplitude.

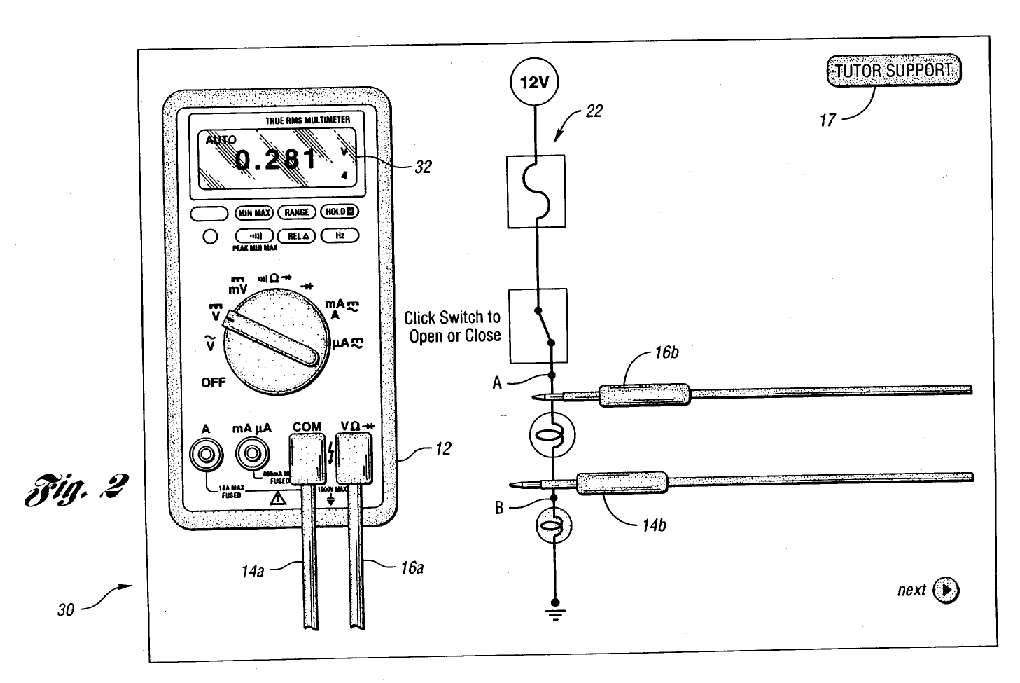

Utilizing interactive GUIs such as those illustrated in FIGS. 1 and 2, a student user can effectively “play” with the physical device—configure and reconfigure the device. The student can also use or otherwise apply the device in a simulated real-world environment. These activities may be performed interactively or over and over, without any risk of harm to real device or application. The student can “learn-by-doing” in a hands-on and trial-and-error fashion—without repercussion.

FIG. 3 is an example interactive GUI 40 showing a manner in which the student user can test his or her ability to configure and use the physical device (e.g., multi-meter 12) properly. In this example, a series of tasks 42 are provided that require the student to configure the multi-meter 12 and apply the multi-meter to the circuit 22 in a variety of specific manners. In this example, the student is asked to read the resulting measurement 32 from the multi-meter and input that measurement into corresponding text boxes 44.

In this example, the student can “check” his or her answers by selecting a “Check Answers” button 46. In response, the interactive GUI 40 provides the student with an indication 48 as to whether the answer the student input is the correct answer. In this example, answers having a check mark 48 are correct and answers having an “X” are incorrect. Of course, the student user can reconfigure the meter and leads, re-enter the resulting measurement, and re-check his or her answers. Accordingly, the student learns how to properly configure and use the particular device in a hands-on fashion.

Notably, simulated interactive devices such as the multi-meter example shown in FIGS. 1-3 may be incorporated into an online quiz or examination in which the student must configure or use a simulated device in a particular fashion, or derive a particular action or result with the device. These quizzes or examinations may be timed requiring that the student perform particular tasks within a fixed period of time.

FIG. 4 is an example interactive GUI 50 that includes instruction 52 for how to use simulated physical device 54 (i.e., a Snap-On MTG2500 Color Graphing Scanner for vehicle diagnosis). Scrollbar 56 in instruction region 52 is provided to enable a student user to scroll through the instruction material without losing site of the particular device 54.

Like the multi-meter example illustrated in FIGS. 1-3, the scanner device 54 shown in FIG. 4 is interactive and configurable by a student user. For example, the user can operate thumb-wheel 58, “Yes” button 60, “No” button 62, etc. to provide input the scanner device 54. Notably, output interface 64 changes in an accurate or true-to-life fashion to reflect such user input.

Instruction identifier 66 (e.g., “Sync Zone 1”) identifies different instruction segments (e.g., lessons, exercises, chapters, instruction paths, etc.). In the example shown in FIG. 4, instruction 52 (including scroll-bar 56) corresponds to “Sync Zone 1”—a lesson for entering the Vehicle Identification Number (VIN) into the simulated scanner device 54.

It is expected that while interactively configuring the simulated device 54, some student users will “get ahead” of the particular instruction segment 66 or otherwise “get lost” in the particular device 54. In many instances, these student users will not be familiar enough with the device to know how to re-configure the device or otherwise get the device configuration back to the current instruction segment reflected in identifier 66.

In a preferred embodiment of the present invention, a synchronizer function may be provided to enable a student user to automatically synchronize the configuration of a simulated physical device to a current instruction segment. In the example shown in FIG. 4, the scanner 54 is synchronized with the instruction segment 66 (compare, device interface 64 to interface 59 shown in instruction 52). Should a student user get the scanner device 54 off-track with instruction 52, the student user can operate synchronizer tab 68a and input a desired instruction segment (e.g., 1—corresponds with the instruction identifier 66).

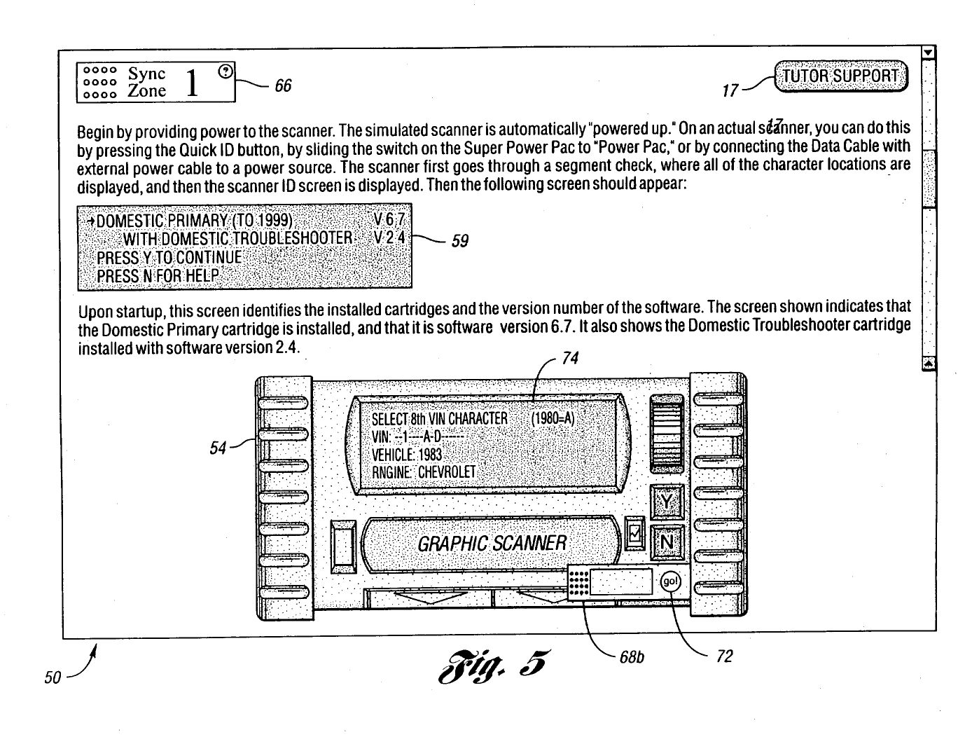

FIG. 5 is an interactive GUI 70 showing the simulated scanner device 54 out-of-sync with the identified instruction segment 66. In this example, a student-user has selected synchronizer tab 68a (shown in FIG. 4) resulting in display of the synchronizer function 68b. To synchronize the scanner device 54 to the instruction segment 66, the student user inputs the desired instruction segment (e.g., “1”) into the synchronizer 68b and selects the “Go” button 72. In response, the simulated scanner device 54 is synchronized with the desired instruction segment. In this example, the synchronized scanner device 54 is shown in FIG. 4 (compare scanner interfaces 64 and 74 of FIGS. 4 and 5, respectively, with interface 59 shown in instruction 52).

In another embodiment of the present invention (not shown), more than one simulated device may be displayed to a user at a time. This embodiment of the present invention may enable a user to interactively interconnect and/or use the devices in a simulated but true-to-life fashion. For example, a user may be presented with a simulated power supply, a simulated signal generator and a simulated oscilloscope, enabling the user to interconnect and interoperate each of the devices in a simultaneous fashion.

Those of ordinary skill in the art will recognize that other means may be employed to enable a user to synchronize a simulated device to a particular instruction set. For example, in an alternate embodiment, the synchronization function may execute automatically, without the necessity of user input.

Those of ordinary skill in the art will recognize that functionality such as that illustrated and described above may be readily provided in an online setting including without limitation a stand-alone software application or an application running in a computer network environment (e.g, via intranet, extranet, Internet, etc.).

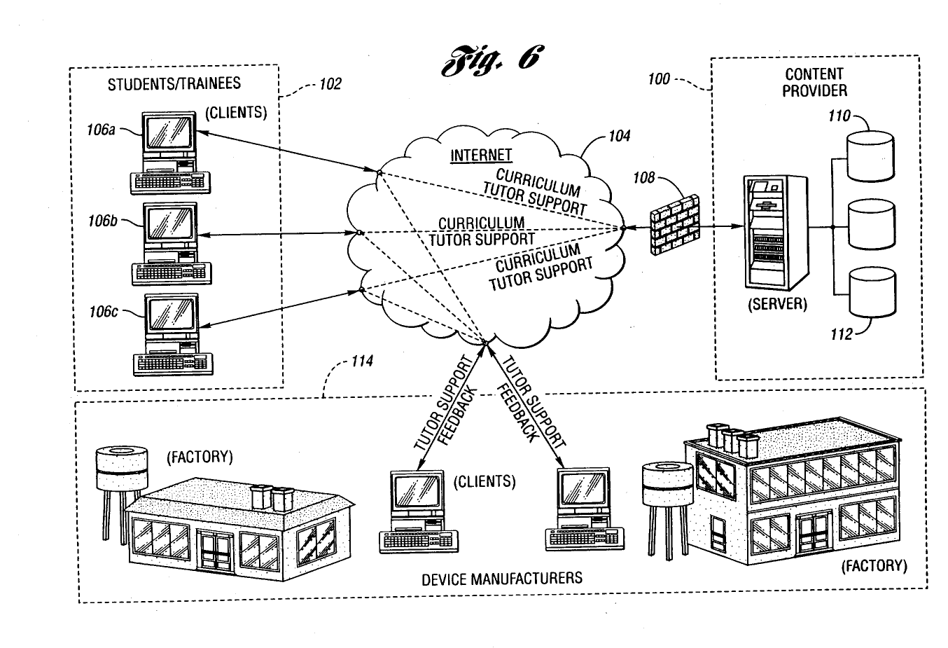

FIG. 6 illustrates an example configuration for implementing the present invention over a computer network, such as the Internet. Those of ordinary skill in the art will recognize that the content and arrangement illustrated in FIG. 6 may be readily adapted to best-fit a particular implementation of the present invention. As illustrated in FIG. 6, content provider(s) 100 serve online curriculum (see, e.g., FIGS. 1-5) to a plurality of students/trainees 102 via a computer network 104 (e.g., WAN, Internet). As illustrated and described in greater detail above, content (e.g., curriculum) and tutor support is preferably presented to students/trainees 102 in a graphical format via the World Wide Web. In accordance with this embodiment, students/trainees 102 view online curriculum via web browser operably installed on client personal computers 106a-c.

Login 108 prevents unauthorized access to content 110. Preferably, students/trainees 102 establish service usage accounts with content provider 100. Usage accounts may define user account properties including but not limited to access privileges (e.g., course content), billing information, etc.

In addition to accessing/downloading curriculum and/or tutor support from content provider 100, operable communication may be provided between students/trainees 102 and device manufacturers 114. In accordance with a preferred embodiment of the present invention, students/trainees 102 can contact or otherwise communicate in an online fashion with manufacturers 114 for tutoring/support and feedback regarding the usability, quality, recommended improvements, etc. relating to devices associated with the online curriculum. Communication between students/trainees 102 may be supported in a variety of online fashions and formats including but not limited to Internet messaging, chat sessions, web cam, e-mail, etc.

In an alternate embodiment (not shown), manufacturer assistance or related content or communication can be hosted at content provider 100.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A computer system for interactively training a user to operate a device, the system comprising at least one computer operably programmed and configured to:
display instruction for using a device;
display an interactive graphical simulation of the device;
receive user input configuring the interactive graphical simulation of the device; and
display a result of the user configuring the device.

2. The system of claim 1 wherein the at least one computer system is additionally programmed and configured to synchronize the configuration of the device to a particular segment of the instruction.

3. The system of claim 1 wherein the instruction requires a user to configure the device in a particular manner and wherein the at least one computer is additionally programmed and configured to display an indication as to whether the result of the user configuration is correct.

4. The system of claim 1 wherein the device is a device for servicing vehicles.

5. The system of claim 3 wherein the device is an electronic device.

6. The system of claim 1 wherein the device is a medical device.

7. The system of claim 1 wherein the system is implemented over the Internet.

8. The system of claim 1 additionally configured to establish online communication between a user of the system and a manufacturer of the device.

9. A computer system for interactively training a user to use a device, the system comprising at least one computer operably programmed and configured to:
display instruction for using a device wherein the instruction comprises multiple segments;
display an interactive graphical simulation of the device;
receive user input configuring the interactive graphical simulation of the device;
display a result of the user configuring the device; and
synchronize the configuration of the device to a particular segment of the instruction.

10. The system of claim 9 wherein the device is a device for servicing vehicles.

11. The system of claim 9 wherein the device is a medical device.

12. The system of claim 9 additionally configured to establish online communication between a user of the system and a manufacturer of the device.

13. Software for instructing a computer system to:
display instruction for using a device;
display an interactive graphical simulation of the device;
receive user input configuring the device; and
display a result of the user configuring the device.

14. The software of claim 13 wherein the software additionally instructs the computer system to synchronize the configuration of the device to a particular segment of the instruction.

15. The software of claim 13 wherein the software additionally instructs the computer system to:
display an instruction for configuring or using the device in a particular manner; and
display an indication as to whether the result of the user configuration is correct.

16. The software of claim 13 wherein the software is embodied in a computer-readable physical article.

17. The software of claim 13 wherein the software is embodied in an electronic file format.

18. The software of claim 13 additionally configured to establish online communication between a user of the system and a manufacturer of the device.

19. An online method for interactively training a user to use a physical device, the method comprising:
providing a user with online instruction for using a device;
providing the user with an interactive graphical simulation of the device in association with the online instruction wherein the user can interactively configure the device.

20. The method of claim 19 additionally comprising synchronizing the configuration of the device with the online instruction.

21. The method of claim 19 additionally comprising providing the user with an indication as to whether the user's configuration is correct.

22. The method of claim 19 additionally comprising providing an online examination wherein the user is required to configure or use the simulated device in a particular manner.

23. The method of claim 19 additionally comprising establishing online communication between a user of the system and a manufacturer of the device.

24. The method of claim 23 wherein the manufacturer of the device provides the user with assistance in using the device.
